(19) United States
(12) Patent Application Publication
(10) Pub. No.: US 2011/0272461 A1
(43) Pub. Date: Nov. 10, 2011

(54) ELECTRONIC READING SYSTEM

(76) Inventor: Yimwai Yau, Yuen Long (CN)

(21) Appl. No.: 13/063,936

(22) PCT Filed: Sep. 16, 2009
(86) PCT No.: PCT/CN2009/073969

§ 371 Date: Apr. 5, 2011

(30) Foreign Application Priority Data
Sep. 16, 2008 (CN) 200820147161.3
Sep. 23, 2008 (CN) 200820147561.4
Sep. 28, 2008 (CN) 200820212084.5

(51) Int. Cl. G06K 7/01; G06K 7/12

(52) U.S. Cl. 235/440

(57) ABSTRACT

The present invention integrates printed books with electronic reading devices. The present invention contains a photoelectric device, at least a data page, and an electronic reading device. The photoelectric device contains an infrared transmitter, a camera, and a photoelectric conversion circuit. The data page has data carrier configured on its surface. The electronic reading device contains a grid antenna circuit board, a radio circuit transmitting signal of a specific frequency, a processor board with a built-in storage or an IC card. The processor board or IC card is capable of converting data retrieved by the photoelectric device into corresponding electronic data so that the content of the electronic data could be read by connected electronic reading device or external card reader.

### TECHNICAL FIELD OF THE INVENTION

The present invention is generally related to the integration of printed books and electronic devices, and more particularly to an electronic reading system capable of detecting invisible codes printed on the book pages.

### DESCRIPTION OF THE PRIOR ART

Various printed documents and material are an essential part of our daily life. Yet, the ways information is presented and delivered by the printed material are rather limited.

Following the advancement of the digital and communication technologies, various media for information delivery are invented, such as the electronic books, learning machines, PDAs.

In the education arena, therefore there is a paperless idea which is intended to reduce children's burden by digitizing and storing printed textbooks a hand-held electronic reading device or a tablet computer. However, this idea has not yet been successfully implemented.

Even though various manufacturers have been continuously pushing new solutions and products into the market, the result is still far from satisfactory.

It turns out that the conventional printed material has advantages such as convenience, simplicity, etc. that cannot be easily replaced by electronic devices. It seems that the printed material cannot be entirely replaced and that conventional publication industry could not treat the digital revolution lightly. It is inevitable that printed material and electronic reading will co-exist.

As such, a new reading style combining printed material and electronic device or media has occurred. For example, there are books accompanied with optical disks, storage cards. There are also books used together with electronic reading devices.

The idea is to store some elements of the printed material in the disks or cards. It is also possible to add interaction capability such as inserting comment, marking, connecting keywords to their explanations, associating with audio and video clips. The main problem is that the disks and cards are required additional device and separate process to gain the additional benefit.

However, integrating printed books and electronic technology is an inevitable trend and researchers have been working diligently to seek breakthroughs.

For example, codes are embedded in the printed book and accessed by optical recognition technique. However, strict printing condition has to be followed and content editing requires professionals.

There are also proposals of integrating RFID with printed books. Theoretically it should be feasible, but it is not a practical solution.

RFID is a non-contact automatic reading technology where an object is identified by radio signal and relevant information is accessed. The object should have an attached tag of unique coding accessible to a reading device. For a book, there are too numerous elements and it is not practical to associate a tag for each of them.

Actually, RFID is not appropriate for reading and it is more appropriate for tracking inventory and supply management.

OCR (Optical Character Recognition) is to convert printed text into digital text by scanning and image processing. Quite a number of devices for the blind are developed using OCR related technologies. The recognition process involves image input, pre-processing, feature extraction, comparison and recognition. Human correction is sometimes inevitable (which is impossible for the blind). Finally, the recognition result is produced.

Touch reader having electronic coordinate sensing is another approach. A printed book is placed on a tablet with grid antenna circuit board and a signal generator touches a data page of the book. The X-Y coordinates of the touched point is determined and electronic data associated with the coordinates is obtained. The working mechanism is as follows. A radio circuit transmits a radio signal of a fixed frequency. The grid antenna circuit detects the radio signal, and filters, amplifies, and transforms the signal before sending it an A/D terminal of processor board. The processor board identifies the X-Y coordinates, accesses a database accordingly, and presents the result on a reading device.

Compared with the foregoing technologies, the touch reader having electronic coordinate sensing seems to be more promising. First, electronic coordinate sensing has superior reliability and resolution and, secondly, its production is simpler and less expensive.

Additionally, electronic coordinate sensing is theoretically appropriate for the blind, especially for synchronous pronunciation.

Electronic coordinate sensing also has its disadvantages. For example, the electronic coordinate circuit board has to be precisely aligned with the printed content. However, this would be a challenge to the blind.

In order to indentify different data pages, the electronic coordinate circuit requires the capability to allow users to select pages. This would be even more challenging to the blind.

On the other hand, the radio circuit cannot radiate too strong or too weak a radio signal. If the radio signal is too strong, there is a high probability of misjudgement of the touched point. If the radio signal is too weak, it cannot penetrated a thick book and cannot be picked up by the electronic coordinate circuit. However, for the books for the blind, they are usually much thicker than the ordinary books.

To successfully integrating printed books and digital technologies, and especially to help the blind in effectively learning and working, the present inventor has already proposed a number of solutions integrating printed books with PDAs such as the Taiwan Patent Application Serial Nos. 2004100792168, 2005100653136, 2005100883778. These teachings, despite their usefulness, still have limited application and some restriction.

### SUMMARY OF THE INVENTION

A major objective of the present invention is to effectively integrate printed books and electronic reading devices.

To achieve the objective, the present invention contains a photoelectric device, at least a data page, and an electronic reading device. The photoelectric device contains an infrared transmitter, a camera, and a photoelectric conversion circuit. The data page has data carrier configured on its surface. The electronic reading device contains a grid antenna circuit board, a radio circuit transmitting signal of a specific frequency, a processor board with a built-in storage or an IC card. The processor board or IC card is capable of converting data retrieved by the photoelectric device into corresponding electronic data so that the content of the electronic data could be read by connected electronic reading device or external card reader.

The grid antenna circuit board contains a number of parallel metallic wires along an X axis interleaved, perpendicularly with a number of parallel metallic wires along a Y-axis into a grid. The grid antenna circuit board is capable of detecting the fixed-frequency radio signal from the radio circuit, and is electrically connected to an A/D portion of the processor board or the IC card.

The grid antenna circuit board, the processor board or IC card are housed in a flat casing having a built-in battery and an external socket. One or more data pages could be placed flatly on the casing, on top of the grid antenna circuit board.

Each data page is printed with invisible codes, each containing a number of miniature graphical elements printed by fluorescent ink. The fluorescent ink is detectable under the infrared light emitted by the infrared transmitter.

Different data pages could have invisible codes of different specifications.

The photoelectric device contains an infrared transmitter, a camera, a photoelectric conversion circuit, and a radio circuit, all housed in a hollow object. The hollow object is mainly composed of a front portion and a back portion. The front portion has a front opening through which the infrared light from the infrared transmitter is radiated. The camera picks up a reflected image also through the front opening. The back portion contains an output circuit which is electrically connected to the processor board or IC card. The radio circuit is electrically connected to a shielding mechanism preventing inductance interference.

Alternatively, the hollow object could be composed of a front portion, a middle portion, and a back portion. The middle portion has a hollow space for accommodating the front portion. The back portion contains a telescoping section and an operation section. The middle section is housed in the telescoping section. The operation section accommodates a built-in battery and an output circuit with a second radio circuit. The radio circuit is electrically connected to a shielding mechanism preventing inductance interference.

Alternatively, the output circuit is configured with a function switch.

Alternatively, an electronic capturing device and an electronic reading device are integrated into a single package. The electronic capturing device is detachably joined to the package.

The electronic capturing device could work with an electronic reading device with card reading capability in a wired manner or with an electronic reading device in a wireless manner. The function of the electronic capturing device becomes part of the electronic reading device.

Multiple data pages could be bound together into an electronic book. Between a front cover and a back cover of the electronic book, a ridge is provided which contains the processor board with build-in storage or IC card. Grid antenna circuit boards could be housed in the front and back covers, and the grid antenna circuit boards could detect the fixed-frequency radio signal from the radio circuit. The grid antenna circuit boards are electrically connected an A/D portion of the processor board with built-in storage or IC card.

The gist of the present invention lies in the novel integration of printed books and electronic reading devices. The printed books could still be read in an ordinary manner while, together with the electronic reading device, a richer reading experience could be achieved.

The processor board or IC card of the present invention is capable of processing the data retrieved by the electronic capturing device into corresponding electronic data so that the associated content could be read by the connected electronic reading device or an external card reader.

The present invention has the following features.

First, the invisible codes on different pages could be of different specification. Therefore, different data could be obtained from different data pages.

Secondly, the grid antenna circuit board is capable of detecting the fixed-frequency radio signal and determining which location on the data page is touched.

Thirdly, the processor board or IC card could contain relevant index data corresponding to the data on the data page.

The present invention is cable of solving the reading problem for the blind by providing synchronous pronunciation. The books for the blind could thereby have a reduced dimension and weight. The learning difficulty and cost for the blind is therefore significantly reduced. The blind could learn and work with greater efficiency, helping them to participate social life more effectively.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1A is a schematic diagram showing a data page is placed on an electronic reading device of the present invention.

FIG. 1B is a schematic diagram showing the interaction between a photoelectric device and an electronic reading device of the present invention.

FIG. 1C is a schematic diagram showing a grid antenna circuit board of an electronic reading device of the present invention.

FIG. 1D is a reference circuit diagram of an electronic capturing device of the present invention.

FIG. 2A is a schematic diagram showing an electronic capturing device of the present invention is a wired embodiment.

FIG. 2B is a schematic diagram showing an electronic capturing device of the present invention is a wireless embodiment.

FIG. 2C is a schematic diagram showing an electronic capturing device of the present invention operated in an OCR mode.

FIG. 2D is a schematic diagram showing an electronic capturing device of the present invention in a collapsible embodiment.

FIG. 2E is a schematic diagram showing the electronic capturing device of FIG. 2D that is collapsed.

FIG. 3A is a schematic diagram showing that multiple data pages are bound into an electronic book.

FIG. 3B is a schematic diagram showing that the electronic book of FIG. 3A is opened.

FIG. 3C is a schematic diagram showing that grid antenna circuit boards are contained in an electronic book's covers.

FIG. 4A is a schematic diagram showing a wired connection to an external electronic reading device.

FIG. 4B is a schematic diagram showing a wireless connection to an external electronic reading device.

FIG. 5A is a schematic diagram showing an electronic capturing device detachably joined to an electronic reading device of the present invention.

FIG. 5B is a schematic diagram showing the electronic capturing device is detached from the electronic reading device of FIG. 5A.

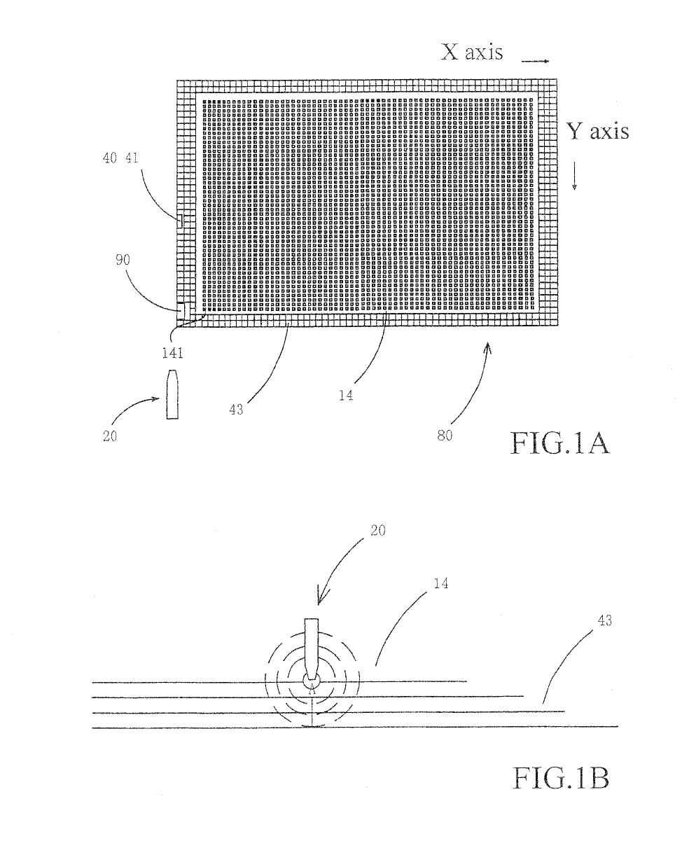

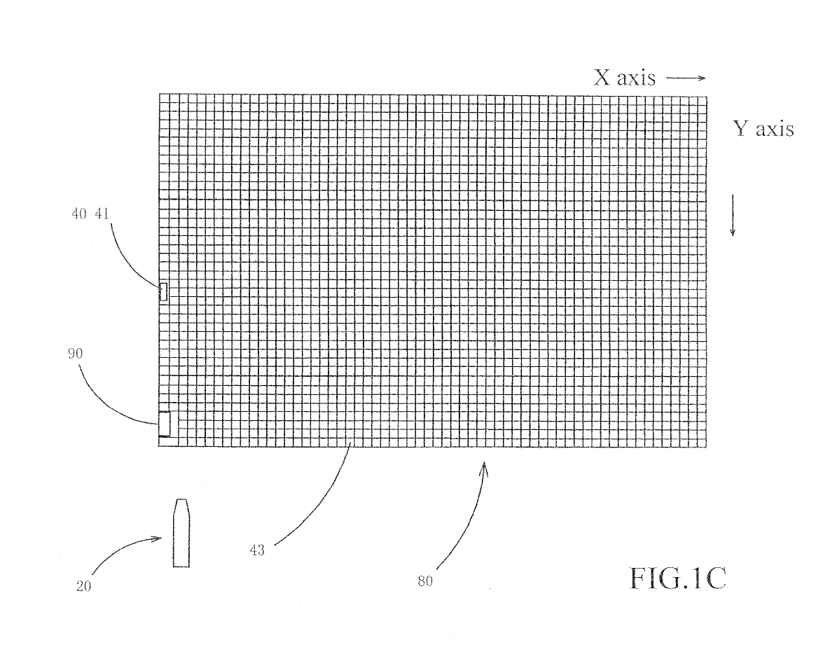

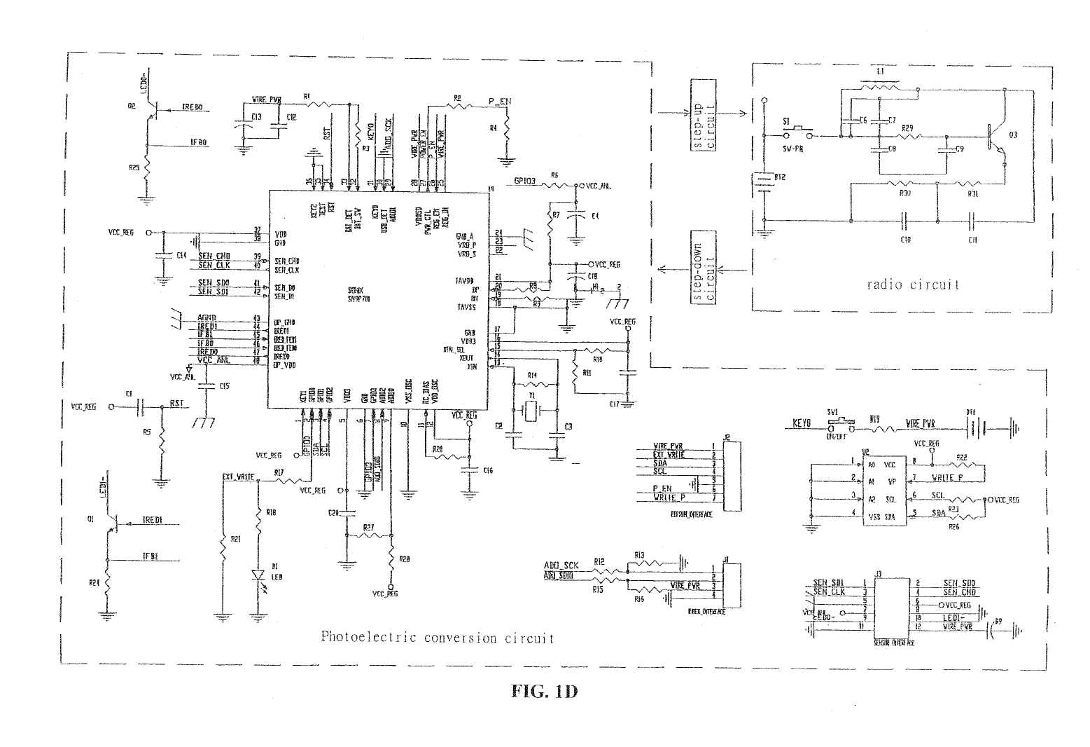

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

According an embodiment of the present invention, the photoelectric device 22 contains an infrared transmitter 221, a camera 222, and a photoelectric conversion circuit 223. The data page 14 has data carrier configured on its surface. The electronic reading device contains a grid antenna circuit board 43, a radio circuit 21 transmitting signal of a specific frequency, a processor board 40 with a built-in storage or an IC card 41. The processor board 40 or IC card 41 is capable of converting data retrieved by the photoelectric device 22 into corresponding electronic data so that the content of the electronic data could be read by connected electronic reading device or external card reader.

The grid antenna circuit board 43 contains a number of parallel metallic wires along an X axis interleaved with a number of parallel metallic wires along a Y-axis into a grid.

The grid antenna circuit board 43 could be made of a flexible conducting film, and is capable of detecting the fixed-frequency radio signal from the radio circuit 21. The grid antenna circuit board 43 is electrically connected to an A/D portion of the processor board 40 or the IC card 41.

The grid antenna circuit board 43, the processor board 40 or IC card 41 are housed in a flat casing 80 having a built-in battery and an external socket 90. One or more data pages 14 could be placed flatly on the casing 80, on top of the grid antenna circuit board 43.

Each of the data pages 14 is printed with invisible codes 141, each containing a number of miniature graphical elements forming a single geometric pattern, Arabic numbers, Roman numerals, English alphabet, or character combinations. Different data pages 14 could have invisible codes 141 of different specifications. The miniature graphical elements are printed by fluorescent ink and are difficult to detect visually. They are however detectable under the infrared light emitted by the infrared transmitter 221.

As the miniature graphical elements are barely detectable by human vision, the printed content by ink not absorbing infrared on the data pages 14 is not affected. The printed content therefore could be overlapped or not overlapped with the invisible codes 141.

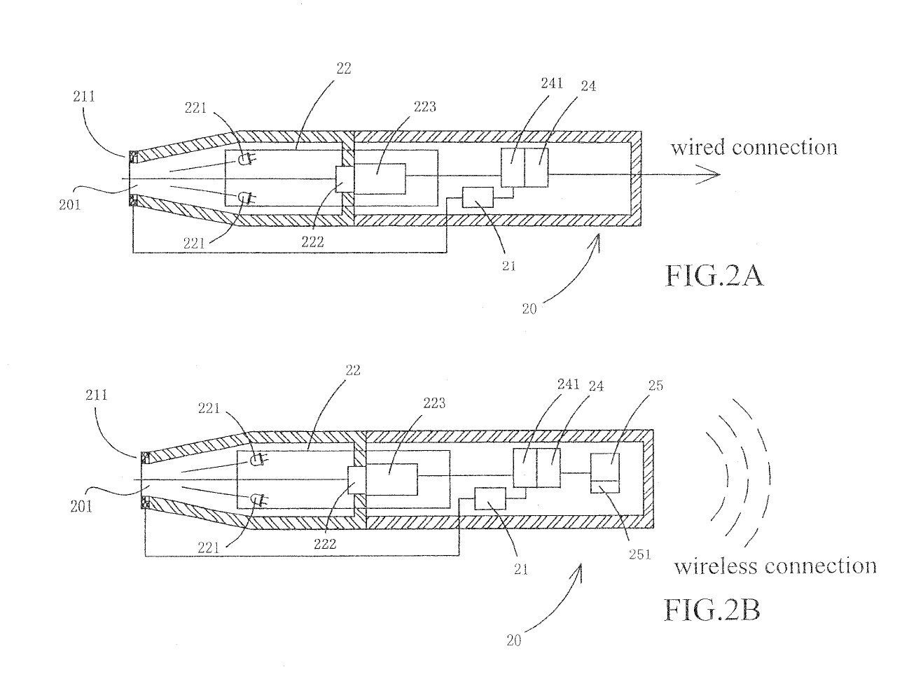

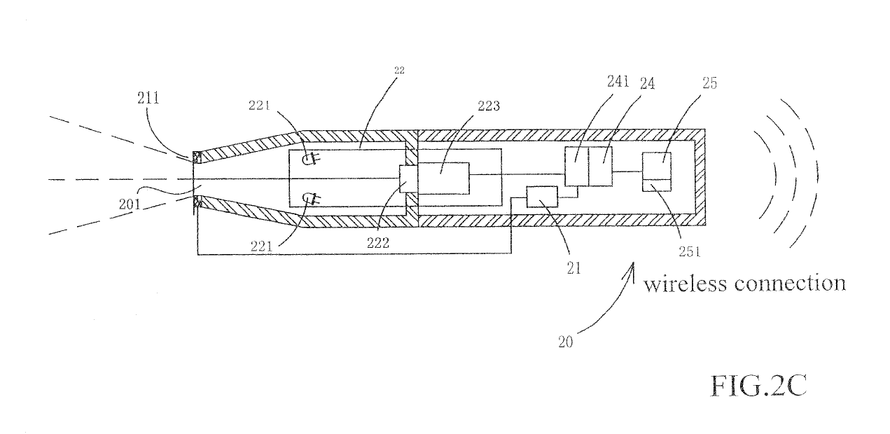

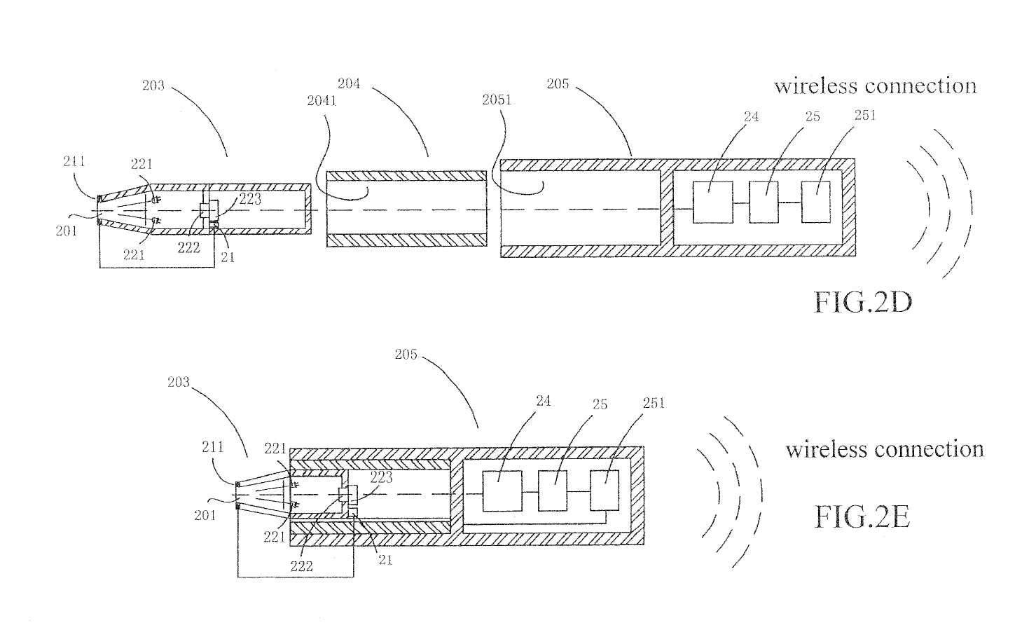

As shown in FIG. 2, the photoelectric device 22 contains an infrared transmitter 221, a camera 222, a photoelectric conversion circuit 223, and a radio circuit 21, all housed in a hollow object. The hollow object is mainly composed of a front portion 203 and a back portion 205. The front portion 203 has a front opening 201 through which the infrared light from the infrared transmitter 221 is radiated. The camera 222 picks up a reflected image also through the front opening 201. The back portion 205 contains an output circuit 24 which is electrically connected to the processor board 40 or IC card 41. As such, whether the data page 14 has ink-printed content or no ink-printed content (but with Braille characters), the electronic capturing device 20 is capable of obtaining the invisible codes 141 on the data pages 14.

Even though multiple data pages 14 are stacked, the electronic capturing device 20 will not detect the invisible codes 141 on the lower data pages 14, as long as the infrared transmitter 221 is tuned appropriately.

Around the front opening 201, a metallic antenna 211 is configured and electrically connected to the radio circuit 21. The radio circuit 21 is electrically connected to a shielding mechanism preventing inductance interference.

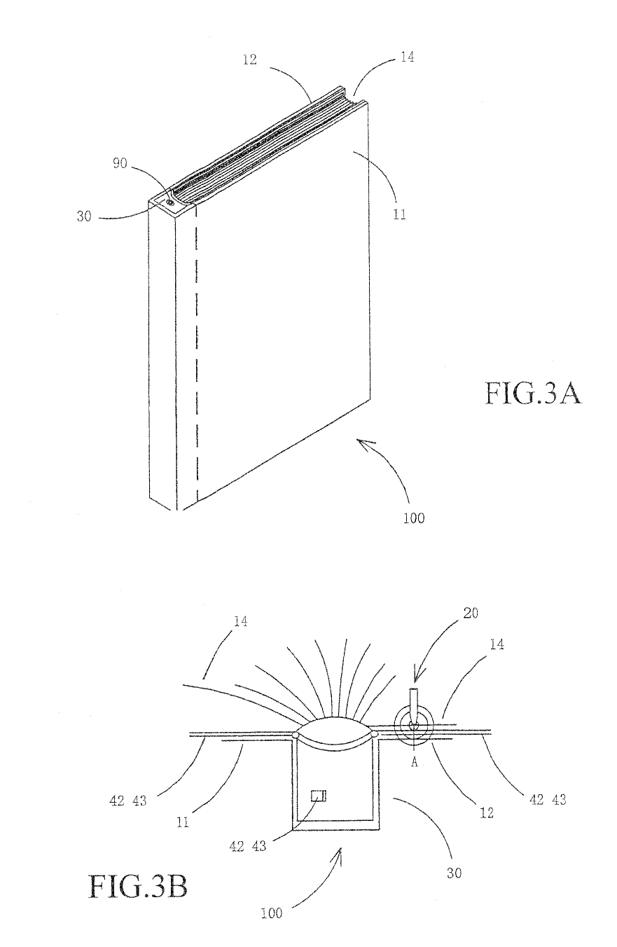

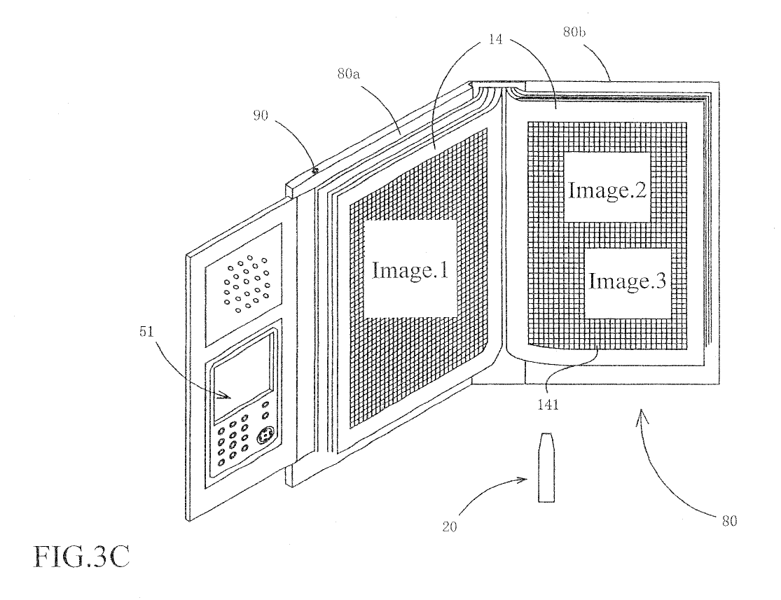

As shown in FIG. 3B, the radio circuit 21 transmits a fixed-frequency signal for the grid antenna circuit board 43 to detect. When location A on a data page is touched, the grid antenna circuit board 43 would detect the fixed-frequency signal, process it, and deliver it to the processor board 40 or IC card 41. The X-Y coordinates to the location A then can be determined.

Based on the location data and other data obtained by the electronic capturing device 20 such as the invisible codes, the processor board 40 or IC card 41 produces related electronic data and the associated content (such as text, images, audio and video, etc.) could be accessed by a connected electronic reading device or card reader.

As shown in FIGS. 2D and 2E, alternatively, the hollow object is mainly composed of a front portion 203, a middle portion 204, and a back portion 205. The front portion 203 has a front opening 201 through which the infrared light from the infrared transmitter 221 is radiated. The camera 222 picks up a reflected image also through the front opening 201. The middle portion 204 has a hollow space 2041 for accommodating the front portion 203. The back portion 205 contains a telescoping section 2051 and a operation section 2052. The middle section 204 is housed in the telescoping section 2051. The operation section 2052 accommodates a built-in battery 251 and an output circuit 24 with a second radio circuit 25. The output circuit 24 transmit data in a wireless manner to the processor board 40 or IC card 41. Around the front opening 201, a metallic antenna 211 is configured and electrically connected to the radio circuit 21. The radio circuit 21 is electrically connected to a shielding mechanism preventing inductance interference.

As described, the photoelectric device 22 could be collapsed for easy storage and transportation.

As shown in FIG. 2, the output circuit 24 is configured with a function switch 241 so as to choose to use the photoelectric device 22 and the radio circuit 21 separately or simultaneously.

As shown in FIG. 2A, the output circuit 24 could also be electrically connected to the processor board 40 or IC card 41 in a wired manner.

As shown in FIG. 2B, the processor board 40 or IC card 41 has a receiver circuit 48 for receiving the radio signal from the second radio circuit 25. As shown in FIG. 2C, the electronic capturing device 20 is in an OCR operating mode.

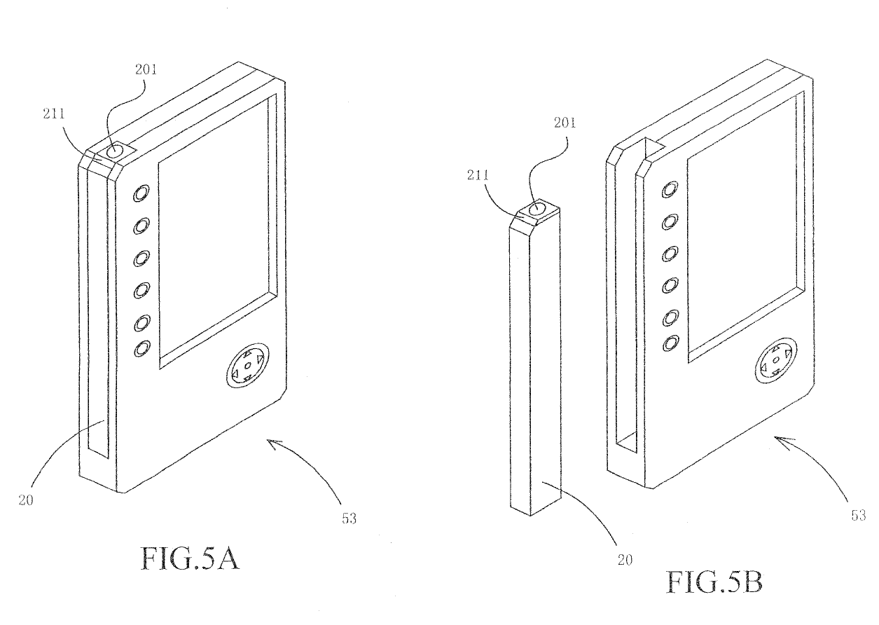

As shown in FIG. 5, an electronic capturing device 20 and an electronic reading device 53 are integrated into a single package. The electronic capturing device 20 is detachably joined to the package. FIG. 5A shows that the electronic capturing device 20 is joined to the electronic reading device 53. FIG. 5B shows that the electronic capturing device 20 is detached from the electronic reading device 53.

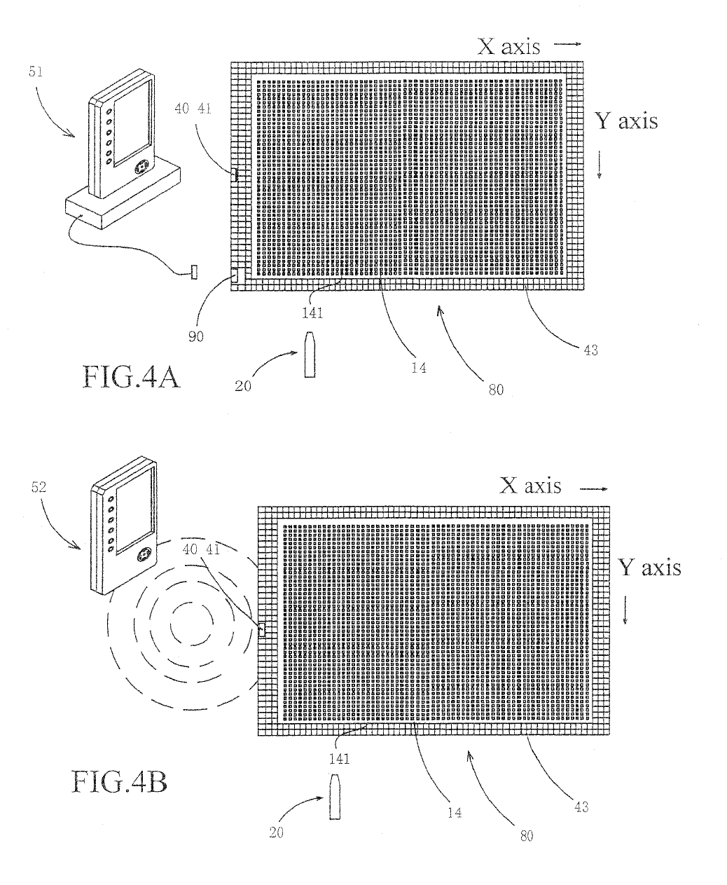

As shown in FIGS. 4A and 4B, the electronic capturing device 20 could work with an electronic reading device 51 with card reading capability in a wired manner or with an electronic reading device 52 in a wireless manner. The function of the electronic capturing device 20 becomes part of the electronic reading device 51 or 52. The present invention could work with the present inventor's another invention titled “ELECTRONIC BOOK WITH CLAMPING DEVICE FOR SUPERPOSITION OF MULTI-BOOKS” where multiple data pages 14 are bound together into an electronic book 100. Between a front cover 11 and a back cover 12 of the electronic book 100, a ridge 30 is provided which contains the processor board 40 with build-in storage or IC card 41. Grid antenna circuit boards 42 and 43 could be housed in the front and back covers 11 and 12, and the front and back covers 11 and 12 could be considered an electronic reading device 80 of the present invention.

As shown in FIG. 3C, Grid antenna circuit boards 42 and 43 could be housed in the front and back covers 80a and 80b, and the grid antenna circuit boards 42 and 43 could detect the fixed-frequency radio signal from the radio circuit 21. The grid antenna circuit boards 42 and 43 are electrically connected an A/D portion of the processor board 40 with built-in storage or 1C card 41.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An electronic reading system, comprising:
a photoelectric device comprising an infrared transmitter, a camera, and a photoelectric conversion circuit;
at least a data page having a data carrier configured on the surface; and
an electronic reading device comprising a grid antenna circuit board, a radio circuit transmitting signal of a specific frequency, and one of a processor board with a built-in storage and an IC card;
wherein said processor board or IC card is capable of converting data retrieved by said photoelectric device into corresponding electronic data so that the content of said electronic data is read by said electronic reading device or an external card reader.

2. The electronic reading system according to claim 1, wherein said grid antenna circuit board comprises a plurality of parallel metallic wires along an X axis interleaved perpendicularly with a plurality of parallel metallic wires along a Y-axis; said grid antenna circuit board is capable of detecting said fixed-frequency radio signal from said radio circuit, and said grid antenna circuit board is electrically connected to an A/D portion of said processor board or said IC card.

3. The electronic reading system according to claim 1, wherein said grid antenna circuit board, and said processor board or IC card are housed in a flat casing; and said data page is placed flatly on said casing, on top of said grid antenna circuit board.

4. The electronic reading system according to claim 1, wherein each data page is printed with invisible codes, each containing a plurality of miniature graphical elements using fluorescent ink detectable under an infrared light emitted by said infrared transmitter; and different data pages have invisible codes of different specifications.

5. The electronic reading system according to claim 1, wherein said infrared transmitter, said camera, said photoelectric conversion circuit, said radio circuit, and an output circuit are housed in a hollow object; said hollow object has a front opening through which an infrared light from said infrared transmitter is radiated; said camera picks up a reflected image through said front opening; said output circuit is electrically connected to said processor board or IC card; and said radio circuit is electrically connected to a shielding mechanism preventing inductance interference.

6. The electronic reading system according to claim 1, wherein said infrared transmitter, said camera, said photoelectric conversion circuit, said radio circuit, a battery, and an output circuit are housed in a hollow object; said hollow object has a front portion, a middle portion, and a back portion; said infrared transmitter, said camera, said photoelectric conversion circuit, said radio circuit are housed in said front portion; said front portion has a front opening through which an infrared light from said infrared transmitter is radiated; said camera picks up a reflected image through said front opening; said front portion is housed in said middle portion; said back portion contains a telescoping section and an operation section; said middle portion is housed in said telescoping section; said battery and said output circuit is housed in said operation section; and said radio circuit is electrically connected to a shielding mechanism preventing inductance interference.

7. The electronic reading system according to claim 5, wherein said output circuit is configured with a function switch.

8. The electronic reading system according to claim 5, wherein said photoelectric device is detachably joined to said electronic reading device.

9. The electronic reading system according to claim 5, wherein said photoelectric device is capable of working with an electronic reading device with card reading capability in a wired manner or with an electronic reading device in a wireless manner; and said function of the photoelectric device becomes part of said electronic reading device.

10. The electronic reading system according to claim 1, wherein multiple data pages are bound together into an electronic book; between a front cover and a back cover of said electronic book, a ridge is provided which contains said processor board with build-in storage or IC card; grid antenna circuit boards are housed in said the front and back covers, and the grid antenna circuit boards detects said fixed-frequency radio signal from said radio circuit; said grid antenna circuit boards are electrically connected an A/D portion of said processor board with built-in storage or IC card.

11. The electronic reading system according to claim 6, wherein said output circuit is configured with a function switch.

12. The electronic reading system according to claim 6, wherein said photoelectric device is detachably joined to said electronic reading device.

13. The electronic reading system according to claim 6, wherein said photoelectric device is capable of working with an electronic reading device with card reading capability in a wired manner or with an electronic reading device in a wireless manner; and said function of the photoelectric device becomes part of said electronic reading device.
